(19) United States
(12) Patent Application Publication
(10) Pub. No.: US 2026/0236024 A1
(43) Pub. Date: Aug. 13, 2026

(54) COOPERATIVE EXPLORATION SYSTEMS FOR UNKNOWN SPACE BASED ON HETEROGENEOUS AIR-GROUND ROBOTS

(71) Applicant: TONGJI UNIVERSITY, Shanghai (CN)

(72) Inventors: Bin HE, Shanghai (CN); Zhipeng WANG, Shanghai (CN); Kaixuan DING, Shanghai (CN); Yanmin ZHOU, Shanghai (CN); Bin CHENG, Shanghai (CN); Pengpeng ZHANG, Shanghai (CN)

(73) Assignee: TONGJI UNIVERSITY, Shanghai (CN)

(21) Appl. No.: 19/396,646

(22) Filed: Nov. 21, 2025

(30) Foreign Application Priority Data
Dec. 20, 2024 (CN) 202411885306.X

(51) Int. Cl. G05D 1/246; G05D 1/644; G05D 1/69; G05D 101/15; G05D 105/80; G05D 109/10; G05D 109/20; G05D 111/10; G05D 111/30; G05D 111/50; H04B 7/185; H04B 17/318; H04W 4/40

(52) U.S. Cl. CPC G05D 1/246; G05D 1/644; G05D 1/69; H04B 7/18504; H04B 17/318; H04W 4/40; G05D 2101/15; G05D 2105/87; G05D 2109/10; G05D 2109/20; G05D 2111/17; G05D 2111/32; G05D 2111/52

(57) ABSTRACT

Provided is a collaborative exploration system for an unknown space based on a heterogeneous air-ground robot, comprising: an unmanned ground vehicle (UGV) and a plurality of unmanned aerial vehicles (UAVs) loaded on the UGV; wherein the UGV is equipped with a first perception module and a first computing platform configured for constructing a fine-grained map of an environment; each of the plurality of UAVs is equipped with a second perception module and a second computing platform configure for constructing a lightweight map of the environment; and a wireless communication module is disposed in the UGV and each of the plurality of UAVs, and the UGV and the plurality of UAVs communicate via a semi-centralized self-organizing communication mode; when the system performs cooperative exploration for the unknown space, the plurality of UAVs explore unknown regions around the UGV with the UGV as a center; based on the second perception module and the second computing platform of each of the plurality of UAVs, the lightweight map is constructed and transmitted back to the UGV; and the UGV fuses the lightweight map transmitted by each of the plurality of UAVs with the fine-grained map constructed by the UGV through the first perception module and the first computing platform. The system has advantages of strong environmental adaptability and high reliability.

### CROSS-REFERENCE TO RELATED APPLICATIONS

This application claims priority to the Chinese Patent Application No. 202411885306.X, filed on Dec. 20, 2024, the contents of which are hereby incorporated by reference.

### TECHNICAL FIELD

The present disclosure relates to the field of unknown space exploration, and in particular to a collaborative exploration system for an unknown space based on a heterogeneous air-ground robot.

### BACKGROUND

Robots not only can improve the exploration efficiency of an unknown space but also can ensure personnel safety in dangerous or hard-to-reach environments. The robots have important significance for fields such as scientific research, military reconnaissance, and disaster rescue.

However, due to the complexity and unpredictability of the unknown space, a traditional single-robot system often has problems such as incomplete information acquisition and low task execution efficiency when facing a complex and variable unknown environment. Taking an unmanned aerial vehicle (UAV), a ground robot, or an underwater robot as an example, such robots usually have specific functions and applicable operating environments. However, when the robots face a complex unknown space, a single robot not only has difficulty completing comprehensive and efficient exploration tasks but also can only perform tasks in a specific environment, making it difficult to satisfy diverse exploration requirements. For example, although the UAV can quickly cover a large area, the mobility and stability of the UAV are limited in narrow or obstacle-dense environments. The ground robot performs well in terrain adaptability but has difficulty functioning in aerial or underwater environments.

Therefore, developing a robot system that can adapt to complex environments and has efficient collaborative capabilities has become an important direction in current technological development.

A heterogeneous robot system, i.e., a system composed of different types of robots, can leverage respective advantages and complement functions of the different types of robots, thereby achieving more flexible and efficient task execution. For example, the ground robot has advantages in terrain adaptability and payload capacity, while an aerial robot performs well in the field of view and mobility. Through a collaborative work of the heterogeneous robot system, information complementation and optimal task allocation can be achieved. Heterogeneous robot collaborative exploration has great potential, but achieving this goal requires support from various technologies.

Although existing heterogeneous robot systems have made some progress in certain aspects, limitations still exist. For example, the reliability and stability of the communication system still have room for improvement. The accuracy and efficiency of environmental perception and mapping technologies need to be further improved. Task allocation and path planning require higher levels of intelligence and adaptive capabilities.

### SUMMARY

To solve the problems in the background technology, the present disclosure provides a collaborative exploration system for an unknown space based on a heterogeneous air-ground robot. The collaborative exploration system has strong environmental adaptability, accurate and efficient environmental mapping, and high reliability.

One or more embodiments of the present disclosure provide a collaborative exploration system for an unknown space based on a heterogeneous air-ground robot, comprising: an unmanned ground vehicle (UGV) and a plurality of unmanned aerial vehicles (UAVs) loaded on the UGV; wherein the UGV is equipped with a first perception module and a first computing platform configured for constructing a fine-grained map of an environment; each of the plurality of UAVs is equipped with a second perception module and a second computing platform configure for constructing a lightweight map of the environment; and a wireless communication module is disposed in the UGV and each of the plurality of UAVs, and the UGV and the plurality of UAVs communicate via a semi-centralized self-organizing communication mode; when the system performs cooperative exploration for the unknown space, the plurality of UAVs explore unknown regions around the UGV with the UGV as a center; based on the second perception module and the second computing platform of each of the plurality of UAVs, the lightweight map is constructed and transmitted back to the UGV; and the UGV fuses the lightweight map transmitted by each of the plurality of UAVs with the fine-grained map constructed by the UGV through the first perception module and the first computing platform.

### BRIEF DESCRIPTION OF THE DRAWINGS

FIG. 1 is a schematic diagram illustrating a hardware composition of a collaborative exploration system for an unknown space based on a heterogeneous air-ground robot according to some embodiments of the present disclosure;

FIG. 2 is a schematic diagram illustrating a structure of a semi-centralized communication topology according to some embodiments of the present disclosure;

FIG. 3 is a schematic diagram illustrating a process for deploying a communication relay node according to some embodiments of the present disclosure; and

FIG. 4 is a schematic diagram illustrating an exemplary assignment of a plurality of unknown boundaries according to some embodiments of the present disclosure.

### DETAILED DESCRIPTION

The technical solutions in the embodiments of the present disclosure are described clearly and completely below with reference to the accompanying drawings in the embodiments of the present disclosure. Obviously, the described embodiments are a part of the embodiments of the present disclosure, not all of the embodiments. Based on the embodiments in the present disclosure, all other embodiments obtained by a person of ordinary skill in the art without creative efforts shall fall within the scope of protection of the present disclosure.

In some embodiments, a collaborative exploration system for an unknown space based on a heterogeneous air-ground robot, comprising: an unmanned ground vehicle (UGV) and a plurality of unmanned aerial vehicles (UAVs) loaded on the UGV; wherein the UGV is equipped with a first perception module and a first computing platform configured for constructing a fine-grained map of an environment; each of the plurality of UAVs is equipped with a second perception module and a second computing platform configure for constructing a lightweight map of the environment; and a wireless communication module is disposed in the UGV and each of the plurality of UAVs, and the UGV and the plurality of UAVs communicate via a semi-centralized self-organizing communication mode; when the system performs cooperative exploration for the unknown space, the plurality of UAVs explore unknown regions around the UGV with the UGV as a center; based on the second perception module and the second computing platform of each of the plurality of UAVs, the lightweight map is constructed and transmitted back to the UGV; and the UGV fuses the lightweight map transmitted by each of the plurality of UAVs with the fine-grained map constructed by the UGV through the first perception module and the first computing platform.

The heterogeneous air-ground robot refers to a combination of robots of different types that operate in different spaces (air and ground). For example, the heterogeneous air-ground robot may include the plurality of UAVs and the UGV.

The UGV may receive exploration data transmitted by the plurality of UAVs, send task instructions to the plurality of UAVs, and function as a central communication node simultaneously, perform a task of constructing the fine-grained map, and provide support for takeoff and landing of the plurality of UAVs. More descriptions regarding the central communication node and the fine-grained map may be found in the following and related descriptions.

The following contents are a detailed introduction to the collaborative exploration system for the unknown space based on the heterogeneous air-ground robot.

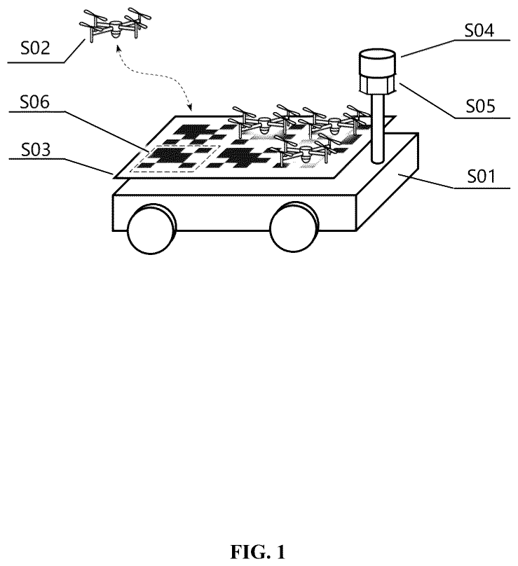

FIG. 1 is a schematic diagram illustrating a hardware composition of a collaborative exploration system for an unknown space based on a heterogeneous air-ground robot according to some embodiments of the present disclosure. As shown in FIG. 1, a hardware portion of the collaborative exploration system for the unknown space based on the heterogeneous air-ground robot may include an unmanned ground vehicle (UGV) S01 and a plurality of unmanned aerial vehicles (UAV) S02.

In some embodiments, the UGV S01 and the plurality of UAVs S02 are each equipped with a perception module and a high-performance computing platform for constructing a fine-grained map and a lightweight map, respectively. The UGV is equipped with a first perception module and a first computing platform, each of the plurality of UAVs is equipped with a second perception module and a second computing platform.

In some embodiments, the first perception module includes a visual sensor for capturing visual information of a surrounding environment, a LiDAR for modeling the environment into a dense point cloud map, and an inertial measurement unit (IMU) for sensing short-term motion data. The second perception module includes a visual sensor for performing lightweight mapping of an overall environment and the IMU for sensing the short-term motion data.

As shown in FIG. 1, the first perception module may include: a horizontally rotating 3D LiDAR S04 for modeling the environment into the dense point cloud map, a surround-view camera S05 for capturing the visual information of the surrounding environment, and an IMU for sensing the short-term motion data (not shown in the figure).

The surround-view camera S05 is installed below the plurality of UAVs. The surround-view camera S05 may rotate an observation angle, so as to allow the UGV to adjust a viewing angle in two working scenarios of perception and takeoff or landing. The LiDAR S04 may be installed at a top of a vertical mast at a rear of a body of the unmanned ground vehicle. The inertial measurement unit (IMU) may be installed inside the UGV near a center of mass of the UGV (not shown in the figure).

By fusing data from the three sensors above, complementary advantages may be achieved, and a problem of perception capability degradation of a single sensor may be avoided. An upper portion of the UGV S01 is provided with a planar platform S03 for parking the plurality of UAVs. A surface of the planar platform S03 is attached with a visual positioning QR code (QR code S06) for calculating a relative pose. When the plurality of UAVs S02 perform tasks of takeoff and landing, the plurality of UAVs S02 activate the surround-view camera S05 to capture the QR code S06, thereby calculating poses of the plurality of UAVs S02 relative to the UGV and planning a safe and fast motion path. More descriptions regarding how to plan the motion path of the UGV may be found in the following and related descriptions.

In some embodiments, the UGV not only needs to carry the plurality of UAVs for a long-distance operation, but also needs to serve as a communication center and a processing center for perception data simultaneously, resulting in high energy consumption. Therefore, the UGV needs to be equipped with a large-capacity energy storage battery.

The computing platform refers to a hardware that performs a computing task. The computing task may include processing perception data, running algorithms, making decisions, or the like. The first computing platform may include a high-performance industrial computer, a computing unit designed for autonomous driving, etc., such as an NVIDIA DRIVE Orin platform embedded with a powerful graphics processing unit (GPU). The second computing platform may include a low-power embedded computing board, etc., such as an NVIDIA Jetson series or a Raspberry Pi.

The fine-grained map refers to a high-precision map containing rich environmental details. For example, the fine-grained map includes a centimeter-level three-dimensional point cloud containing a precise three-dimensional contour of a building, a road surface slope, a location of a lane line, a size and location of a roadside obstacle, etc.

The lightweight map refers to a low-precision map containing only key features. For example, the lightweight map includes a topological map that only records an approximate orientation of a wall, a doorway, and a location of a main obstacle, a low-resolution grid map, etc.

In some embodiments, a wireless communication module is disposed in the UGV and each of the plurality of UAVs. Based on the second perception module and the second computing platform of each of the plurality of UAVs, the lightweight map is constructed and transmitted back to the UGV through the wireless communication module. The plurality of unmanned aerial vehicles transmit the lightweight map back to the unmanned ground vehicle through the wireless communication module, and the UGV fuses the lightweight map transmitted by each of the plurality of UAVs with the fine-grained map constructed by the UGV through the first perception module and the first computing platform.

The wireless communication module refers to a communication tool for an information exchange between robots and is a hardware foundation for achieving data transmission. For example, the wireless communication module includes a Wi-Fi module, a 5G/4G communication module, a Bluetooth module, or a long-range low-power communication module such as LoRa.

Some embodiments of the present disclosure achieve a comprehensive exploration of the unknown space by constructing a collaborative system of the UGV and the plurality of UAVs. The UGV serves as a mobile base, not only providing a platform for takeoff and landing of the plurality of UAVs, but also completing fine-grained modeling of the environment through the sensors and the computing platform carried by the UGV. Each of the plurality of UAVs uses the lightweight sensor and the computing platform to operate for a long time in a low-power mode, thereby achieving lightweight mapping of areas outside a field of view of the UGV. Such a collaborative operation mode enables the entire system to cover a broader space, provide richer environmental information, and significantly improve comprehensiveness and efficiency of exploration.

To ensure communication reliability of the collaborative exploration system for the unknown space based on the heterogeneous air-ground robot in complex environments, the system adopts a semi-centralized self-organizing communication mode for communication. During operation, the system always uses the UGV on the ground as an operation center. The UGV and each of the plurality of UAVs are installed with the wireless communication module, and communication network nodes are formed, which is suitable for using a centralized network structure. The UGV serves as a central communication node of a communication network, and data from each of the plurality of unmanned aerial vehicles is directly transmitted to the UGV, and a UGV-centered communication network is formed.

However, in the complex environments, a flying UAV may lose a communication with the central communication node, causing a communication failure. In response to this, the UAV needs to spontaneously search around for a connectable communication object when the communication between the UAV and the central communication node is interrupted, and establish a connection with another communication node, then a local distributed network structure is formed. Such a structure forms a semi-centralized communication network. The plurality of UAVs explore around with the unmanned ground vehicle as a center, a communication interruption between edge communication nodes and the central communication node for a certain time period and a local communication between the edge communication nodes within a small range are allowed, thereby improving the flexibility and stability of the system. The UAV or a group of UAVs that lose connection with the central communication node plan a timing of return according to operational needs of the UAV or the group of UAVs, thereby restoring the connection between the UAV or the group of UAVs with the central communication node.

In some embodiments, the UGV and the plurality of UAVs communicate via the semi-centralized self-organizing communication mode, and the wireless communication module is configured to: designate the UGV as a central communication node and designating the plurality of UAVs as communication nodes to form a UGV-centered communication network, wherein the UGV and the plurality of UAVs communicate directly or indirectly; when a communication between the UAV and the UGV-centered communication network is interrupted, the UGV determines whether an idle UAV exists at this time; in response to the presence of the idle UAV, dispatch the idle UAV to navigate to a designated position to serve as a communication relay node; in response to the absence of the idle UAV, a disconnected UAV initiating autonomous search for other connectable communication nodes in a surrounding region; if the other connectable communication nodes are found within a preset time interval, directly establish a communication connection; if the other connectable communication nodes are still not found within the preset time interval, the disconnected UAV returning to a position where it was last able to communicate with the UGV-centered communication network; wherein the other connectable communication nodes are the communication relay nodes.

In some embodiments, the designated position is determined by the first computing platform of the UGV through a real-time calculation. The first computing platform determines the preset position suitable for serving as a communication relay within a communication reachable range based on a position of the disconnected UAV, a map of an explored region, and the communication reachable range delineated on a map by the wireless communication module.

The semi-centralized self-organizing communication refers to a communication architecture combining centralized and distributed features.

The UGV-centered communication network refers to an overall network topology formed with the UGV as a center and the plurality of UAVs establishing communication connections around the UGV.

The communication nodes refer to other nodes in the communication network that are able to establish communications besides the central communication node.

The central communication node refers to a central node of the communication network. In the collaborative exploration system for the unknown space based on the heterogeneous air-ground robot, the plurality of UAVs are the communication nodes of the UGV-centered communication network, the UGV is the central communication node of the UGV-centered communication network, and the plurality of UAVs and the UGV communicate directly or indirectly.

The idle UAV refers to a UAV that currently stays on a platform of the UGV and is not assigned an exploration task.

The communication relay node refers to an intermediate node configured to connect two nodes that are unable to communicate directly.

The disconnected UAV refers to an UAV whose communication with the UGV-centered communication network is interrupted.

The preset time interval refers to a maximum allowed time consumption for the disconnected UAV to search for other connectable communication nodes. The preset time interval may be preset manually.

The disconnected UAV returns to a position where the disconnected UAV could previously communicate with the UGV-centered communication network, to maintain a communication connection with the UGV-centered communication network.

Some embodiments of the present disclosure utilize the semi-centralized self-organizing communication mode to combine overall planning by the UGV with autonomous coordination of the plurality of nodes. The semi-centralized self-organizing communication mode implements direct or indirect connections between the plurality of UAVs and the center via the wireless communication module. When the communication is interrupted, the semi-centralized self-organizing communication mode prioritizes scheduling the idle UAV to serve as the relay to restore a communication link. In response to the absence of idle nodes, the disconnected UAV initiates autonomous search for other connectable communication nodes or returns to reconnect, thereby effectively solving communication interruption problems caused by signal occlusion and excessive distance in complex unknown environments, significantly improving the survivability and self-healing capability of a communication network, and also reducing manual intervention, so as to ensure the continuity and stability of data transmission and command interaction in air-ground collaborative exploration.

In some embodiments, the collaborative exploration system for the unknown space based on the heterogeneous air-ground robot sets the plurality of UAVs and the UGV as the communication nodes, and uses a UANET to construct a self-organizing communication network. The UANET has advantages of self-organization, strong flexibility, and fast networking speed, and is able to satisfy communication requirements between the UGV and the plurality of UAVs.

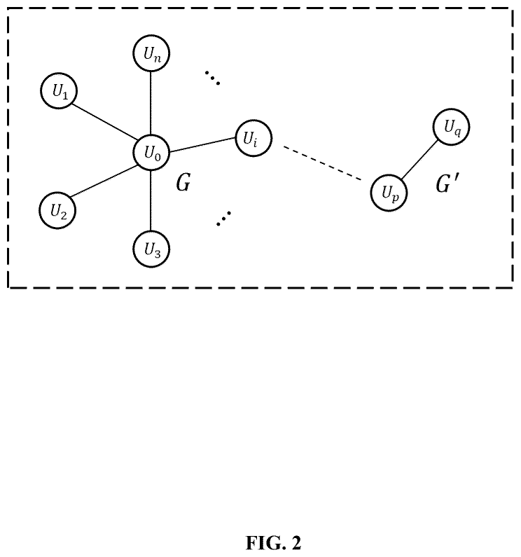

Based on the UANET self-organizing communication network, the collaborative exploration system for the unknown space based on the heterogeneous air-ground robot uses a semi-centralized communication topology for networking. The semi-centralized communication topology uses the UGV as the central communication node and the plurality of UAVs as the communication nodes to construct the communication link, as specifically shown in FIG. 2.

FIG. 2 is a schematic diagram illustrating a structure of a semi-centralized communication topology according to some embodiments of the present disclosure. As shown in FIG. 2, a UGVa UGV U₀ is a central communication node of a UGV-centered communication network. The UAV Uᵢ(i=1, . . . , n) is wirelessly connected to the UGV via a wireless communication module, and a star topology network structure is formed. The topology is represented by the following formula (1):

$$G = < V , E > , V = \{ {U}_{i} \vert i = 0 , 1 , … , n \} , E = \{ ( {U}_{0} , {U}_{i} ) \vert i = 1 , … , n \} , \qquad ( 1 )$$

In formula (1), G represents a graph structure composed of a vertex set V and an edge set E. The graph structure represents a communication network structure composed of the UGV U₀ and n UAVs Uᵢ(i=1, . . . , n). The vertex set V includes the plurality of UAVs and the UGV. The edge set includes a communication connection established between the UGV and each of the plurality of the UAVs.

When an independent UAV group appears, the UAVs within the group communicate with each other individually, and a communication network graph independent of the central communication node is formed. The communication network graph G′ is represented by the following formula (2):

$${G}^{′} = < {V}^{′} , {E}^{′} > , {V}^{′} = \{ {U}_{p} , {U}_{q} \} , {E}^{′} = \{ ( {U}_{p} , {U}_{q} ) \} \qquad ( 2 )$$

In formula (2), G′ represents a graph structure composed of a vertex set V′ and an edge set E′. The graph structure is used to describe a communication network structure of the independent UAV group (i.e., a local communication network graph independent of the central communication node).

The independent UAV group refers to a temporary collaborative group spontaneously formed by a plurality of UAVs within a same communication range. The independent UAV group is formed because the plurality of UAVs experience communication interruption with the UGV-centered communication network due to the complex environment and are unable to restore communication via other relay communication nodes (UAVs). The independent UAV group does not rely on command scheduling from the central communication node. The independent UAV group may implement data interaction and collaborative operations through direct communication within the group. After the communication condition is restored, the independent UAV group reconnects to the UGV-centered communication network.

During a process where the independent UAV group moves away from or approaches the UGV-centered communication network, a connection between two adjacent UAVs automatically disconnects when a distance between the two adjacent UAVs exceeds an effective communication range. Conversely, the connection is re-established when the distance returns to within the communication range. When the UAV stably communicates with the central communication node, a multi-hop chain topology structure is formed between an end UAV (an end communication node, responsible for a perception task) and the central communication node (the UGV). Each of the plurality of UAVs in the chain acts as a communication relay node, thereby implementing an indirect data transmission between the central communication node and the end UAV. During flight, a communication signal strength of thea UAV is susceptible to environmental structures. When the UAV explores the complex environment, once an obstacle causes a signal attenuation, and the data transmission requires a good communication condition, the multi-hop chain topology communication network structure described above can effectively satisfy a transmission requirement.

In some embodiments, when the communication network (also referred to the UGV-centered communication network) includes a UAV that serves only as a communication relay node Uᵢ (also referred to as a relay UAV Uᵢ), a relative position of the relay UAV relative to preceding and succeeding communication nodes (Uᵢ₋₁, Uᵢ₊₁) of the relay UAV Uᵢ has a significant impact on communication effectiveness. Therefore, the relay UAV Uᵢ needs to dynamically adjust its own position according to the real-time position changes of the preceding and succeeding communication nodes of the relay UAV Uᵢ, and this process is the autonomous scheduling of the communication relay node Uᵢ.

In some embodiments, an implementation of a scheduling function of the communication relay node Uᵢ relies on a dual foundation:

On the one hand, a UGV Uᵢ₋₁ constructs a surrounding environment map (a fine-grained map) via a first perception module carried by itself while moving. The constructed map is a map of an explored region M. The communication relay node (the UAV) Uᵢ uses the map (the fine-grained map) constructed by the UGV Uᵢ₋₁ as a basis for navigation, proceeds to an unknown boundary for exploration, and transmits back newly acquired environment information (a lightweight map) to update the map. Under a condition that a local map (the map of the explored area) is known, the communication relay node is able to achieve self-positioning and navigation based on a second perception module carried by the communication relay node and the map of the explored region constructed by the UGV Uᵢ₋₁. The communication relay node Uᵢ is also able to, according to an instruction sent by the UGV, use a search-based algorithm to calculate an optimal path connecting the preceding and succeeding communication nodes of the communication relay node. A target position of the communication relay node Uᵢ is along the optimal path and as close as possible to a next communication node Uᵢ₊₁ (i.e., an end communication node Uᵢ₊₁). This provides a motion foundation for the autonomous scheduling of the communication node.

On the other hand, after calculating the optimal path between the two communication nodes before and after the communication relay node, the unmanned aerial vehicle serving as the communication relay node starts from a current position of the unmanned aerial vehicle serving as the communication relay node Uᵢ and flies along the optimal path from a position close to a superior node (the unmanned ground vehicle Uᵢ₋₁) towards an inferior node (the end communication node Uᵢ₊₁). Simultaneously, the unmanned ground vehicle monitors communication signal strength between the plurality of communication nodes in real time via the wireless communication module. When the strength is less than a preset threshold, the unmanned aerial vehicle serving as the communication relay node Uᵢ lands to execute a communication relay task. This provides a decision basis for the autonomous scheduling of the communication relay node.

The optimal path refers to a best communication path connecting the preceding and succeeding communication nodes of the communication relay node. For example, the optimal path satisfies conditions such as short distance, few obstacles, and low signal interference. In some embodiments, the optimal path may be calculated by the search-based algorithm. The search-based algorithm may be an A-star (A*) algorithm, a Dijkstra algorithm, or the like.

The end communication node refers to a node farthest from the central communication node on a communication link and directly responsible for an environment perception task (e.g., photographing, exploring).

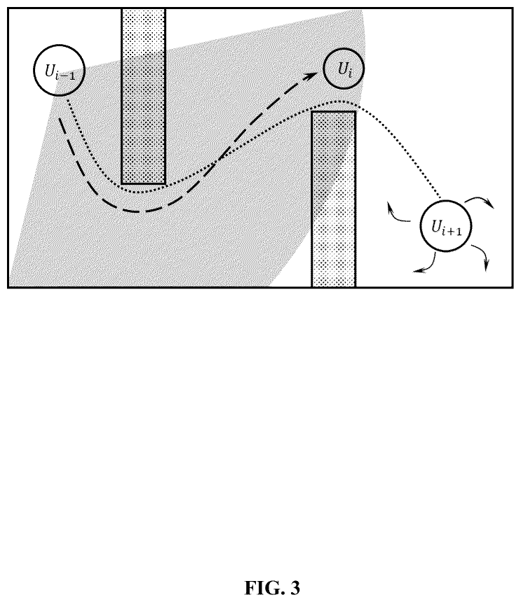

FIG. 3 is a schematic diagram illustrating a process for deploying a communication relay node according to some embodiments of the present disclosure.

In some embodiments, as shown in FIG. 3, the communication relay node moves only within a map of an explored region M, and uses a search-based algorithm to calculate an optimal path connecting preceding and succeeding communication nodes Uᵢ₋₁ and Uᵢ₊₁ of the communication relay node Uᵢ. A communication node farthest from the central communication node on the communication link is designated as the end communication node. The end communication node is responsible for the perception task. A target position of the communication relay node is as close as possible to a next node along the optimal path. After calculating the optimal path between the preceding and succeeding communication nodes of the communication relay node, a UAV served as the communication relay node starts from a current position of and flies along the optimal path from a position close to an upper node toward a lower node. Simultaneously, a wireless communication module monitors a strength of a communication signal, and when the strength is less than a preset threshold, the UAV served as the communication relay node lands to perform the communication relay task.

The map of the explored region refers to a map that a UGV has explored and constructed.

The search-based algorithm refers to a computer algorithm used to find the optimal path from a start point to an end point in a map or graph. For example, the search-based algorithm may be an A* algorithm, a Dijkstra algorithm, or the like.

The communication link refers to a link formed by sequentially connecting communication nodes and used for transmitting data. For example, the communication link may be formed by sequentially connecting the central communication node, the communication relay node, and the end communication node.

The target position refers to a position that the communication relay node needs to finally reach to perform the communication relay task at the target position. The communication relay task refers to a specialized task of the communication relay node to maintain communication and forward data.

The strength of the communication signal refers to a physical quantity that characterizes and measures the strength of wireless signal transmission between the communication nodes.

The preset threshold refers to a minimum strength of the communication signal that satisfies transmission requirements. The preset threshold may be preset manually. While the UAV served as the communication relay node flies along the optimal path, the wireless communication module monitors the strength of the communication signal. When the strength is less than the preset threshold, the UAV serving as the communication relay node stops flying to avoid an excessively weak strength of the communication signal affecting communication.

Some embodiments of the present disclosure, by limiting a movement of the communication relay node within the map of the explored region, combining with planning the optimal path using the search-based algorithm, clarifying functions of the end communication node and the target position of the communication relay node, and pairing with a signal monitoring during flight and a threshold-triggered landing mechanism, not only ensure motion safety and path efficiency of the communication relay node, but also maintain communication by approaching the lower node and landing in a timely manner. This effectively avoids the signal interruption in complex environments, ensures a stable connection of the communication link, provides reliable support for perception data transmission back by the end communication node and command issuance by the center, and further improves the communication stability and task execution efficiency of system collaborative exploration.

In some embodiments, if only one unknown boundary exists in a map, exploration is performed in a UGV individual exploration mode, and an unknown boundary tracking algorithm is used to complete an exploration task, specifically: using a geometric center of the unknown boundary as a target point for path planning, and using a search-based path planning manner to obtain a walking path to a target boundary. During a continuous operation of the UGV, the unknown boundary continuously recedes, and the UGV is configured to calculate the target point once every time the UGV travels a certain distance.

The UGV individual exploration mode refers to an operation mode in which only the UGV independently performs environment exploration, mapping, and path planning tasks, without relying on collaboration from the plurality of UAVs.

The unknown boundary refers to a boundary of an unexplored region, i.e., a junction line between the explored region and the unexplored region.

The unknown boundary tracking algorithm is used to identify a position of the unknown boundary in the map and guide the UGV to move towards the unknown boundary. The unknown boundary tracking algorithm may include a boundary following algorithm, a frontier-based exploration (FBE) algorithm, or the like.

The target point refers to a position set for path planning of the UGV that the UGV needs to ultimately reach. The target point may be the geometric center of the unknown boundary.

In some embodiments, when an individual UGV performs the exploration task, if a large blind region appears in the environment, the UGV needs to change an original movement direction and move to a position that is able to cover the blind region. If a branch structure appears in the environment, the UGV needs to sequentially move to different branches to expand a field of view and determine a road condition ahead. In both cases above, the UGV needs to perform a plurality of round-trip movements, resulting in low movement efficiency and high energy consumption costs. For the UGV and the plurality of UAVs performing collaborative air-ground exploration, when the UGV carries the plurality of UAVs to collaboratively explore an unknown environment, if the environment is open without branch paths, only the first perception module carried by the UGV is sufficient to perform good mapping of the environment. If an environmental blind region appears, the UGV may maintain an original movement trajectory, and a UAV may move to cover the blind region. If the branch structure appears in the environment, the UAV may move to perform a rough exploration (i.e., construct a lightweight map) to assist the UGV in selecting a better walking path. More descriptions regarding constructing the lightweight map may be found in the following and related descriptions.

In a simple environment, the map of the explored region M includes only a main unknown boundary F (not shown in the figure). A collaborative exploration system for an unknown space based on a heterogeneous air-ground robot performs exploration in the UGV individual exploration mode. Only a simple unknown boundary tracking algorithm is needed to complete the exploration task. For the unknown boundary, the geometric center of the unknown boundary F is calculated. The geometric center is used as a target point P_{target} for path planning, as shown in the following formula (6):

$${P}_{targ e t} = Center ( F ) \qquad ( 6 )$$

Center (F) represents a geometric center of the unknown boundary F.

The search-based path planning manner is then used to generate an optimal path to the target point. During a continuous operation of the UGV, a position of the unknown boundary F also continuously recedes. If a target position is repeatedly calculated in real time, computational power consumption of the collaborative exploration system for the unknown space based on the heterogeneous air-ground robot increases. Meanwhile, frequently updated target positions have differences, which may cause the UGV to oscillate in a walking direction, resulting in an energy loss in movement. Therefore, the collaborative exploration system for the unknown space based on the heterogeneous air-ground robot specifies that the UGV calculates the target position only after traveling a certain distance (e.g., a preset fixed distance threshold), so as to reduce an update frequency of the target position, thereby balancing computational and movement energy consumption while ensuring exploration accuracy.

Some embodiments of the present disclosure adopt the UGV individual exploration mode when only one unknown boundary remains in the map. An unknown boundary tracking algorithm is used with the geometric center of the boundary as the target point, the search-based path planning manner is combined to obtain the walking path, and the target position is updated after traveling a certain distance is specified. This approach not only adapts to simple environments to reduce collaborative costs, but also balances computational and movement energy consumption through a reasonable target point update mechanism. The UGV is ensured to efficiently and stably advance toward the unknown area, thereby improving the economy and continuity of the exploration task.

In some embodiments, when the UGV and the plurality of UAVs collaboratively explore the unknown space, the plurality of UAVs explore unknown regions around the UGV with the UGV as the center. When a plurality of unknown boundaries appear in a map, the first computing platform on the UGV calculates and outputs, via a reinforcement learning algorithm, an unknown boundary index for a next step assigned to the UGV for exploration according to a fused map of the explored region and a set of current unknown boundaries, and assign each remaining secondary unknown boundary to the UAV to explore; when the plurality of UAVs departs from the UGV, the UGV stops and waits, and determines a next exploration boundary according to an exploration result of the plurality of UAVs. The reinforcement learning algorithm uses a path length L traveled by the UGV and an elapsed time T as a reward and penalty item of reinforcement learning to dynamically optimize assignment of the plurality of unknown boundaries; and by learning a structural distribution feature in the environment, the UGV selects an unknown boundary with a highest exploration value score from the plurality of unknown boundaries for exploration.

More descriptions regarding how the first computing platform fuses to obtain the map of the explored region may be found in the following and related descriptions.

In some embodiments, in the map of the explored region, the collaborative exploration system for the unknown space based on the heterogeneous air-ground robot traverses the map to identify all “free” voxels adjacent to “unknown” voxels. These discrete boundary voxels are spatially clustered. A continuous three-dimensional surface formed by each cluster constitutes an independent unknown boundary.

The unknown boundary index refers to a unique identifier assigned to an unknown boundary to distinguish different unknown boundaries.

In some embodiments, after identifying all unknown boundaries, the first computing platform may assign digital indexes to the unknown boundaries in a specific order (e.g., from largest to smallest area, or from left to right in spatial position).

In some embodiments, the reinforcement learning algorithm may be a deep Q-network (DQN), proximal policy optimization (PPO), or the like. The reinforcement learning algorithm aims to minimize the path length L traveled by the UGV and the elapsed time T as optimization objectives. The path length L and the elapsed time T are used as negative reward and penalty items in a reward function for optimization. The reinforcement learning algorithm dynamically optimizes the assignment of the plurality of unknown boundaries, and by learning a structural distribution feature in the environment, the UGV selects an unknown boundary with the highest exploration value score from the plurality of unknown boundaries for exploration.

The path length L refers to a total length from a current position of the UGV to the unknown boundary. In some embodiments, the path length L may be obtained based on the map of the explored region using a search-based algorithm (e.g., an A* algorithm, a Dijkstra algorithm, etc.).

The elapsed time T refers to a time spent by the UGV moving from the current position to the unknown boundary. In some embodiments, the elapsed time T may be calculated based on the path length L and a preset speed of the UGV.

The structural distribution feature in the environment refers to an environmental feature such as a terrain, an obstacle, and a spatial layout within an exploration region.

The exploration value score is a numerical value used to quantify a potential exploration benefit of the unknown boundary. The higher exploration value score indicates a greater expected benefit from exploring the unknown boundary.

In some embodiments, the exploration value score may be learned internally by the reinforcement learning algorithm. The reinforcement learning algorithm learns to assign a higher exploration value score to unknown boundaries that yield higher rewards by continuously selecting different unknown boundaries for trial and receiving reward and penalty values.

The secondary unknown boundary refers to an unknown boundary not assigned to the UGV and planned to be explored by the UAV.

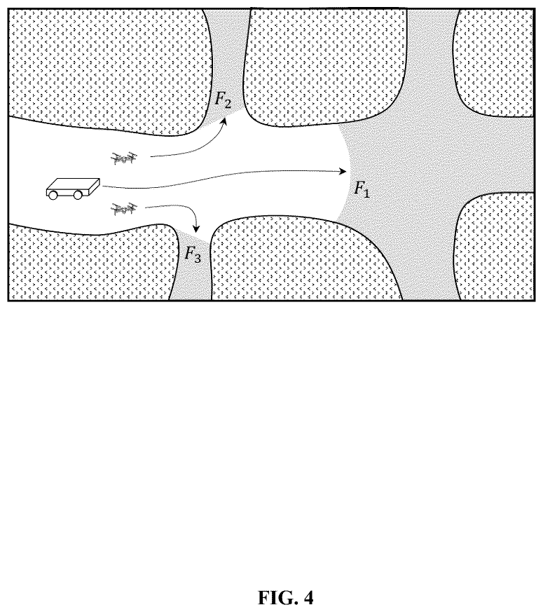

FIG. 4 is a schematic diagram illustrating an exemplary assignment of a plurality of unknown boundaries according to some embodiments of the present disclosure. As shown in FIG. 4, in the complex environment, the blind region or the branch path may appear in the exploration region. The map of the explored region M may contain more than one unknown boundary Fᵢ(i=1, 2, . . . ). An exploration cost and an exploration value differ among the different unknown boundaries. The exploration cost includes a path length to the unknown boundary, a probability that a region behind the unknown boundary is a closed region requiring a return trip, etc. The exploration value is related to factors such as a size of exploration space behind the unknown boundary, an openness degree, and shape possibilities. Therefore, all unknown boundaries need to be evaluated and ranked. Since the UGV is a center of an exploration team, the unknown boundary with the highest exploration value score should be assigned to the UGV for the exploration task, and the secondary unknown boundaries are assigned to the plurality of UAVs for exploration to achieve an optimal resource allocation.

Considering that the exploration cost and exploration value of the unknown boundary are difficult to quantify explicitly, a simulation scenario needs to be designed according to an actual application scenario. The reinforcement learning algorithm is used to learn the environmental structural distribution feature in the scenario, thereby selecting the unknown boundary suitable for exploration by the UGV from the plurality of unknown boundaries.

To improve simulation efficiency, in a virtual scenario, a communication and perception process are simplified. A communication between the UGV and the plurality of UAVs is assumed to be unobstructed, and perception capabilities of the UGV and the plurality of UAVs are assumed to be equivalent to a field-of-view coverage range, thereby accelerating operation. A virtual air-ground collaborative system is used for exploration. A reinforcement learning model receives the map M of the explored area and the current set of unknown boundaries {Fᵢ|i=1, 2, . . . } as input. The reinforcement learning model f(·) outputs an identifier of a next unknown boundary ID to be assigned to the unmanned ground vehicle for exploration. Each remaining unknown boundary (i.e., a secondary unknown boundary) is automatically assigned to an unmanned aerial vehicle for exploration. After exploration in the virtual scenario is completed, the path length L traveled by the unmanned ground vehicle and the elapsed time T are used as a reward and penalty item for reinforcement learning, as shown in the following equation (4). This enables the collaborative exploration system for an unknown space to learn a selection strategy for unknown boundaries, as shown in the following formula (3):

$$ID = f ( M , \{ {F}_{i} \} ) \qquad ( 3 )$$

$$R = - α ( L + T ) \qquad ( 4 )$$

R represents a reward and penalty value for reinforcement learning, and R is used to train the reinforcement learning model to learn an optimal selection strategy. α is a weight coefficient used to adjust influence degrees of the path length L and the elapsed time T on the reward and penalty value. The reward and penalty item refers to a numerical feedback used in reinforcement learning to evaluate a quality of an action (selecting a certain unknown boundary). A positive value is a reward, and a negative value is a penalty.

In some embodiments, the secondary unknown boundary is explored by the UAV. The UAV is constrained by communication and movement capabilities, so the UAV needs to move within a range centered on the UGV. Each secondary unknown boundary is assigned to one UAV for exploration. When the UAV moves away from the UGV, the UGV stops and waits. This approach is able to maintain a stable communication environment and allow a determination of a next unknown boundary to explore based on an exploration result of the UAV. Similarly, the unknown boundary tracking manner is used, a centroid of the unknown boundary is first calculated, and the search-based path planning algorithm is then used to generate a path, guiding the UAV to a selected unknown boundary for exploration. The UAV uses a camera for environmental perception. Due to a narrow field of view, the UAV needs to move back and forth along the unknown boundary to achieve a region coverage, thereby gradually pushing the unknown boundary back. Meanwhile, the UAV creates a lightweight map and records key visual information, and transmits the lightweight map and the key visual information to the UGV. Regarding the construction of the lightweight map, the UAV uses an existing visual and inertial sparse mapping manner, which primarily satisfies needs for self-localization and perceiving a general structure of the environment. To ensure a long-distance communication, when a distance between the UAV and the UGV is too far, causing a communication rate to drop below a standard threshold (which may be preset based on experience), the UGV dispatches an additional UAV as a communication relay node to perform a communication relay task, thereby increasing an exploration range of a forward UAV.

In some embodiments, at most one UAV serving as the communication relay node is allowed between the UGV and a UAV for forward perception.

It should be noted that a count of UAVs is limited. A maximum number of secondary unknown boundaries for exploration must not exceed the count of UAVs. When an idle UAV is available, the at most one UAV serving as the communication relay node is allowed between the UGV and the UAV for forward perception. When no idle UAV is available, a UAV for perception has no support from the communication relay node and may only perform the exploration task within a signal range of the UGV.

Some embodiments of the present disclosure limit the count of communication relay nodes between the UGV and the UAV for forward perception to at most one. This can ensure stability of communication link while avoiding resource waste and increased decision complexity caused by too many communication relay nodes, thereby efficiently maintaining communication quality and resource utilization in air-ground collaborative exploration.

In some embodiments, a maximum exploration range of the UAV for forward perception is jointly determined by the communication capabilities of the UGV and the communication relay node. An unknown region behind the unknown boundary presents two situations. If the unknown region is a small enclosed space, a range of the unknown region may be completely covered by an exploration range. After exploration, no new unknown boundary is generated. If the unknown region is a large enclosed space or an open space exceeding the exploration range of the UAV, new unknown boundaries still exist.

After the UAV completes exploration, the UGV makes a decision based on new unknown boundaries and moves to the next unknown boundary with the highest exploration value score. At this time, the UAV returns and lands on the UGV. The UAV travels with the UGV to a new target position, and the UAV and the UGV await a next collaborative exploration task in a scenario with the plurality of unknown boundaries.

In some embodiments, if the count of UAVs is less than a count of unknown boundaries, the UAV may explore an unknown boundary index, so as to enable the UAV to fly along a boundary direction corresponding to the unknown boundary index explored by the UGV. More descriptions regarding the contents herein may be found in the following and related descriptions.

Some embodiments of the present disclosure use the first computing platform of the UGV to fuse the map and unknown boundary information. The reinforcement learning algorithm is employed with the path length and the elapsed time as reward and penalty basis to dynamically optimize boundary assignment. The UGV focuses on high-value unknown boundaries, while the plurality of UAVs collaboratively explore the secondary unknown boundaries. A waiting mechanism of the UGV adapts to an exploration pace of the plurality of UAVs. This approach not only improves efficiency of multi-boundary exploration in complex environments, but also enhances rationality of task assignment by learning environmental features, order and efficiency of air-ground collaborative exploration are ensured.

There are two situations: a situation where the first computing platform satisfies a first preset condition and a situation where the first computing platform does not satisfy the first preset condition. There are also two situations: a situation where a distance between each of the plurality of UAVs and the UGV exceeds a distance threshold and a situation where the distance between each of the plurality of UAVs and the UGV does not exceed the distance threshold. In response to the first computing platform not satisfying the first preset condition, the first computing platform is configured to normally perform a computing task.

In some embodiments, the second computing platform is configured to: in response to the first computing platform satisfying the first preset condition and the distance between each or the plurality of UAVs and the UGV not exceeding the distance threshold, output the unknown boundary index via the reinforcement learning algorithm according to a fused map of the explored region and the set of current unknown boundaries; in response to the first computing platform satisfying the first preset condition and the distance between each of the plurality of UAVs and the UGV exceeding the distance threshold, output UAV motion parameters via the reinforcement learning algorithm, the UAV motion parameters including a movement direction of each of the plurality of UAVs. A state space of the reinforcement learning algorithm includes a self-location, a battery level, and a communication quality metric of each of the plurality of UAVs; an action space is defined as the movement direction of each of the plurality of UAVs; a reward function is constructed based on an exploration area growth rate and an energy consumption metric of each of the plurality of UAVs; the exploration area growth rate is an area of a newly covered unknown region per unit time; the energy consumption metric is determined based on a movement distance and a count of direction changes of each of the plurality of UAVs; and based on the UAV motion parameters, control a flight control system of each of the plurality of UAVs to cause each of the plurality of UAVs to fly along the movement direction.

In some embodiments, the first preset condition is used to determine whether the computing task of the UGV needs to be migrated to the plurality of UAVs. The first preset condition may be that a computing load of the first computing platform exceeds a preset percentage of a maximum computing power of the first computing platform, or that a duration of a communication interruption between the first computing platform and the second computing platform exceeds a first time threshold. The first time threshold may be preset manually based on historical experience.

In some embodiments, if the first computing platform satisfies the first preset condition, the first computing platform of the UGV is incapable of supporting the computing task, or the first computing platform is disconnected from the second computing platforms of the plurality of UAVs. Since data required by the computing task is collected by the plurality of UAVs, when the first computing platform satisfies the first preset condition, the computing task originally planned to be performed on the UGV may be directly processed by a processor array formed by the second computing platforms of the plurality of UAVs through distributed computing.

The UAV processor array refers to a unified distributed computing cluster formed by temporarily networking the second computing platforms of the plurality of unmanned aerial vehicles through a wireless local area network.

In some embodiments, the distance between each of the plurality of UAVs and the UGV refers to a three-dimensional spatial Euclidean distance between the UGV and each of the plurality of UAVs, the distance may be estimated by a global positioning system module or a visual odometry module built into the UGV.

The distance threshold refers to a maximum distance used to define that each of the plurality of UAVs has not exceeded a limited range of the UGV. The distance between each of the plurality of UAVs and the UGV not exceeding the distance threshold indicates that each of the plurality of UAVs has not flown out of the limited range of the UGV, i.e., each of the plurality of UAVs has not entered a map exploration state. The distance threshold may be determined manually based on task requirements and an effective range of a wireless communication module.

In some embodiments, when the first computing platform satisfies the first preset condition and the distance between each of the plurality of UAVs and the unmanned ground vehicle does not exceed the distance threshold, the second computing platform may use the fused map of the explored region and the set of current unknown boundaries as the input to the reinforcement learning model, and output a next unknown boundary index assigned to the unmanned ground vehicle for exploration through reinforcement learning. More descriptions regarding the content herein may be found in the foregoing descriptions.

In some embodiments, when the first computing platform satisfies the first preset condition and the distance between the unmanned aerial vehicle and the unmanned ground vehicle exceeds the distance threshold, the second computing platform of the unmanned aerial vehicle immediately activates an intelligent decision-making mechanism, i.e., outputs UAV motion parameters through the reinforcement learning algorithm, and controls the flight control system of the unmanned aerial vehicle based on the UAV motion parameters to cause the unmanned aerial vehicle to fly along the movement direction.

The UAV motion parameters refer to parameters related to guiding autonomous flight of each of the plurality of UAVs. In some embodiments, the UAV motion parameters may include the movement direction of each of the plurality of UAVs. The movement direction of each of the plurality of UAVs may include, but is not limited to, forward, backward, turn left, turn right, ascend, descend, or the like.

The state space of the reinforcement learning is used to describe an information set of a current state of the UGV, and may serve as an input to the reinforcement learning algorithm. In some embodiments, the state space of the reinforcement learning may include the self-location, the battery level, the communication quality metric of each of the plurality of UAVs, or the like.

The self-location of each of the plurality of UAVs may be obtained through a global positioning system (GPS), a visual odometry system, or the like on each of the plurality of UAVs.

In some embodiments, the battery level of each of the plurality of UAVs may be represented by a percentage of remaining battery capacity relative to a full battery capacity. The battery level of each of the plurality of UAVs may be obtained through a battery management system of each of the plurality of UAVs.

A communication quality of each of the plurality of UAVs may be represented by a strength of a communication signal monitored and acquired by a communication module.

The action space of the reinforcement learning refers to the movement direction of each of the plurality of UAVs.

In some embodiments, the reward function of the reinforcement learning algorithm may be constructed based on both the exploration area growth rate and the energy consumption metric of each of the plurality of UAVs. The reward function may be expressed as:

$${R}_{1} = {α}_{1} * A + {β}_{1} * H \qquad ( 5 )$$

R₁ is a reward value of the reinforcement learning algorithm. A is the exploration area growth rate of each of the plurality of UAVs, and H is the energy consumption metric of each of the plurality of UAVs. Weight coefficients α₁ and β₁ may be positive values preset manually according to requirements.

The exploration area growth rate refers to an area of a newly covered unknown region per unit time by each of the plurality of UAVs.

In some embodiments, the exploration area growth rate is a difference between the area of a newly covered unknown region and an area of the map of the explored region from a previous step, divided by a time step.

The energy consumption metric refers to an indicator characterizing a battery consumption situation of each of the plurality of UAVs.

In some embodiments, the energy consumption metric is determined based on the movement distance and the count of direction changes of each of the plurality of UAVs. For example, the energy consumption metric may be obtained by weighted summation of the movement distance and the count of direction changes. The movement distance of each of the plurality of UAVs may be obtained through a visual odometry of each of the plurality of UAVs, and the count of direction changes may be obtained based on recorded data of the flight control system. In some embodiments, weight coefficients for the movement distance and the count of direction changes may be preset manually. Before calculating the energy consumption metric, the movement distance and the count of direction changes may be normalized to convert into dimensionless values.

The reinforcement learning algorithm is configured to train the reinforcement learning model. The input of the reinforcement learning model is the self-location of each of the plurality of UAVs, the battery level of each of the plurality of UAVs, and the communication quality metric of each of the plurality of UAVs. An output of the reinforcement learning model is the movement direction of each of the plurality of UAVs. The reinforcement learning model is trained in a virtual environment. During a training process, the reinforcement learning algorithm uses the exploration area growth rate A of each of the plurality of UAVs and the energy consumption metric H of each of the plurality of UAVs as a basis for calculating the reward function. By optimizing a long-term cumulative reward, each of the plurality of UAVs learns the UAV motion parameters for autonomous flight of each of the plurality of UAVs.

In some embodiments of the present disclosure, system robustness under abnormal conditions such as failure of a core computing power of the UGV is significantly improved through distributed computing power and an autonomous decision-making mechanism of the plurality of UAVs. When a core computing power of the UGV fails, near-field UAVs may form a temporary processor array to collaboratively complete key decisions such as assignment of the plurality of unknown boundaries, thereby achieving dynamic migration of computing tasks and graceful degradation of system functions. Far-field UAVs rely on a local reinforcement learning algorithm to autonomously determine the movement direction of each of the plurality of UAVs based on the exploration efficiency and the energy consumption metric, so as to enable the far-field UAVs to continue performing valuable exploration tasks even after communication with the UGV is interrupted, and to intelligently return when necessary, thereby maintaining basic operation and task continuity of the collaborative exploration system for the unknown space under extreme conditions.

In some embodiments, the second computing platform is further configured to: in response to the first computing platform satisfying a second preset condition and the distance between each of the plurality of UAVs and the UGV exceeding the distance threshold, periodically perform following operations according to a preset period: determine a semantic label based on surrounding environment visual information, short-term motion data, and key visual frame data within the preset period, and transmit the semantic label back to the first computing platform, the semantic label including the self-location and a risk label of each of the plurality of UAVs. A cycle length of the preset period is related to an exploration benefit ratio.

In some embodiments, the second preset condition is used to trigger an operation mode in which each of the plurality of UAVs transmits the semantic label back to the UGV. The second preset condition may be that a computing load of the first computing platform exceeds a preset percentage of a maximum computing power of the first computing platform, and a duration of a communication interruption between the first computing platform and the second computing platform is less than a second time threshold. The second time threshold may be set manually based on historical experience, and the second time threshold needs to be less than the first time threshold.

The preset period refers to a period during which each of the plurality of UAVs performs lightweight data processing. In some embodiments, the cycle length of the preset period is related to the exploration benefit ratio. The preset period may be dynamically adjusted according to the exploration benefit ratio. A larger exploration benefit ratio corresponds to a smaller cycle length of the preset period, so as to increase a data transmission frequency of each of the plurality of UAVs. The cycle length may be 5 min, 7 min, or the like.

The exploration benefit ratio is an indicator for measuring an exploration benefit obtainable per unit exploration distance. In some embodiments, for each boundary direction, the second computing platform may determine the exploration benefit ratio based on the exploration area growth rate and the exploration distance. For example, the exploration benefit ratio may be expressed as a ratio of the exploration area growth rate to the exploration distance.

The surrounding environment visual information refers to image data of a surrounding environment. In some embodiments, the surrounding environment visual information may be acquired by a visual sensor.

The short-term motion data refers to self-motion state information of each of the plurality of UAVs within the preset period. For example, the short-term motion data includes a linear acceleration, an angular velocity, or the like. In some embodiments, the short-term motion data may be directly obtained by an inertial measurement unit on each of the plurality of UAVs.

The key visual frame data refers to image frames extracted by each of the plurality of UAVs from the surrounding environment visual information. For example, the key visual frame data includes image frames where key objects such as corners, road signs, or obstacles appear. In some embodiments, each of the plurality of UAVs may obtain the key visual frame data from a continuous image sequence through a visual simultaneous localization and mapping (SLAM) front end or a feature point detection algorithm.

The semantic label may include a self-location and the risk label of each of the plurality of UAVs.

The risk label may include a passable and safe region (e.g., a flat ground, an open corridor, or the like), a non-passable region (e.g., a wall, a water surface, or the like), and a passable and dangerous area (e.g., a pit edge, a cliff, a construction area, or the like).

The semantic label extraction model may be a machine learning model, e.g., a neural network (NN), or any one or a combination of other custom model structures.

In some embodiments, an input of the semantic label extraction model may include the surrounding environment visual information within the preset period, the short-term motion data, and the key visual frame data, and an output of the semantic label extraction model may include the semantic label.

In some embodiments, the semantic label extraction model may be trained based on a large number of first training samples with first labels. A processor may input a plurality of first training samples with the first labels into an initial semantic label extraction model, construct a loss function based on the first labels and a result of the initial semantic label extraction model, and iteratively update parameters of the initial semantic label extraction model based on the loss function through a manner such as gradient descent. When the loss function satisfies a preset condition, a trained semantic label extraction model is obtained. The preset condition may include convergence of the loss function, a count of iterations reaching a threshold, or the like.

The first training samples and the first labels may be obtained based on historical data. Each of the plurality of first training samples may include historical surrounding environment visual information, historical short-term motion data, and historical key visual frame data within a first historical period. A first label corresponding to each of the plurality of first training samples may include a historical actual self-location of each of the plurality of UAVs and a historical risk label. The historical actual self-location of each of the plurality of UAVs is obtained by actual monitoring such as global positioning system (GPS) monitoring. The historical risk label is annotated manually based on the historical key visual frame data.

In some embodiments of the present disclosure, by dynamically adjusting the preset period based on the exploration benefit ratio, each of the plurality of UAVs online lightweights multi-source perception data into the semantic label containing the self-location and the risk label of each of the plurality of UAVs and transmits the semantic label back to the UGV. This approach ensures effective upload of key information while significantly reducing communication load and processing pressure on the first computing platform, thereby maintaining monitoring capability and global situational awareness for each of the plurality of UAVs performing frontier exploration under non-ideal communication conditions.

In some embodiments, the first computing platform is further configured to: based on the plurality of semantic labels transmitted back by the plurality of UAVs within the preset time period, determine the next exploration boundary; after determining the next exploration boundary, periodically perform following operations according to the preset period: based on the plurality of semantic labels transmitted back by the plurality of UAVs, updating the self-locations of the plurality of UAVs, and discarding data transmitted back by the plurality of UAVs.

The exploration boundary refers to an unknown boundary that needs to be explored.

In some embodiments, the preset time period may be preset manually based on experience. For example, the preset time period may be the past 30 seconds, 20 seconds, or the like.

In some embodiments, for each of the plurality of UAVs, the first computing platform may calculate a proportion of a count of risk labels that are passable and safe regions among a plurality of semantic labels transmitted back by the UAV within the preset time period, and record the proportion as a proportion of a safe region of the UAV. The first computing platform may use a boundary explored by a UAV with the highest proportion of the safe region as the next exploration boundary.

In some embodiments, after determining the next exploration boundary, the first computing platform of the UGV may update the self-location of the UAV based on the self-location of the UAV in a latest semantic label transmitted back by the UAV, and discard historical data.

In some embodiments of the present disclosure, by performing lightweight fusion and decision-making on the semantic labels at a side of the UGV, optimized allocation of system computing resources is achieved. By parsing environmental risk information in the semantic labels, the UGV can quickly evaluate the possibility convenience and potential risks of various exploration directions, thereby formulating an efficient global exploration strategy. Meanwhile, the UGV extracts only the self-location of the UAV from the semantic label for state tracking, and immediately discards accompanying raw data. This processing mechanism significantly reduces the data processing load on the UGV, so as to allow core computing power to focus on path planning of the UGV and high-precision map construction tasks, thereby achieving optimized allocation of computing resources at a system level.

In some embodiments, the second computing platform is further configured to: in response to a count of UAVs being less than a count of unknown boundaries, determine UAV exploration parameters based on the count of UAVs and the count of unknown boundaries, the UAV exploration parameters including the unknown boundary index and an exploration distance explored by each of the plurality of UAVs; based on the UAV exploration parameters, control the plurality of UAVs to obtain exploration area growth rates for a plurality of boundary directions; based on the exploration area growth rates and the exploration distance, determine a plurality of exploration benefit ratios corresponding to the plurality of boundary directions; based on the plurality of exploration benefit ratios, determine the unknown boundary index explored by each of the plurality of UAVs; and based on the unknown boundary index explored by each of the plurality of UAVs, control a flight control system of each of the plurality of UAVs to cause each of the plurality of UAVs to fly along a boundary direction corresponding to the unknown boundary index explored by each of the plurality of UAVs.

More descriptions regarding the exploration area growth rate and the unknown boundary index may be found in the foregoing description and related descriptions.

In some embodiments, when the count of UAVs is less than the count of unknown boundaries, it indicates that the collaborative exploration system for the unknown space based on the heterogeneous air-ground robots is unable to assign a dedicated UAV to explore each of the plurality of unknown boundaries. In this case, a mismatch exists between exploration resources and task requirements, and an allocation strategy of the UAVs needs to be optimized to improve overall exploration efficiency.

The UAV exploration parameters refer to parameters related to guiding the exploration flight of each of the plurality of UAVs. In some embodiments, the UAV exploration parameters include the unknown boundary index and the exploration distance explored by each of the plurality of UAVs.

The exploration distance refers to a preset flight distance for a single exploration of each of the plurality of UAVs for evaluating the exploration benefit ratio.

In some embodiments, the exploration distance may be related to a quantity difference between the UAVs and the unknown boundaries. A larger quantity difference obtained by subtracting the count of UAVs from the count of unknown boundaries corresponds to a smaller exploration distance, so as to achieve a rapid exploration of the plurality of unknown boundaries.

In some embodiments, the second computing platform may have various manners for determining the UAV exploration parameters based on the count of UAVs and the count of unknown boundaries. For example, first, all n unknown boundaries are sorted according to a preset rule to generate a boundary list. Subsequently, a cyclic allocation algorithm is used to sequentially assign the unknown boundaries in the boundary list to m UAVs in a cyclic order (n is greater than m). That is, a first unknown boundary is assigned to a first UAV, a second unknown boundary is assigned to a second UAV, . . . , an m-th unknown boundary is assigned to an m-th UAV, an (m+1)-th boundary is reassigned to the first UAV, and so on, until all n unknown boundaries are assigned. Through this allocation mechanism, each of the plurality of UAVs ultimately obtains a list containing at least floor (n/m) unknown boundary indices, thereby ensuring that all unknown boundaries are assigned. Meanwhile, the exploration distance is combined to jointly constitute complete UAV exploration parameters.

The preset rule may be preset manually. For example, the preset rule includes arranging according to a straight-line distance from a geometric center of the unknown boundary to the UGV (from far to near or from near to far), arranging according to an estimated spatial area enclosed by each of the plurality of unknown boundaries (from large to small or from small to large), or the like.

In some embodiments, the second computing platform may sort all boundary directions in a descending order of the exploration benefit ratio to obtain a sorting result. The second computing platform may select top n boundary directions from the sorting result, and randomly assign the top n unknown boundaries to n UAVs. The boundary directions correspond one-to-one to the unknown boundary index for UAV exploration, i.e., each of the plurality of UAVs may determine the unknown boundary index for UAV exploration.

In some embodiments, the second computing platform may control the flight control system of each of the plurality of UAVs based on the unknown boundary index for the UAV exploration, so as to cause each of the plurality of UAVs to fly along the boundary direction corresponding to the unknown boundary index for the UAV exploration.

In some embodiments of the present disclosure, the autonomous exploration system of the UAV group can intelligently perform task allocation and path planning based on real-time acquired environmental information and states of the UAVs. Through segmentation of the unknown boundaries and dynamic allocation of tasks, the plurality of UAVs can collaborate efficiently to achieve rapid exploration of the unknown region. Meanwhile, during the exploration process, each of the plurality of UAVs generates a lightweight map in real time and transmits key information back to the UGV. The UGV then performs map fusion and updates boundary information based on the lightweight map and the key information, and further optimizes exploration tasks and paths of each of the plurality of UAVs.

In some embodiments, the first computing platform of the UGV performs visual dense low-precision mapping according to the lightweight map, short-term motion data, and key visual frame data transmitted back by the plurality of UAVs; adjusts a pose in the lightweight map transmitted back by the plurality of UAVs by using a spatial point cloud scaling and registration manner, deletes a low-precision map at an overlapping region, aligns a boundary of the fine-grained map constructed by the UGV to obtain a dual-precision map; during a process of the UGV advancing toward the lightweight map, continuously uses the first perception module of the UGV to perform mapping, generates a new fine-grained map, and constantly moves a boundary of the fine-grained map and a boundary of the lightweight map backward.

More descriptions regarding the key visual frame data may be found in the foregoing and related descriptions.

The visual dense low-precision mapping refers to a map construction manner that is generated based on visual data and that has a high pixel or point cloud density but a low precision.

The spatial point cloud scaling refers to a manner of adjusting a size ratio of point cloud data in a map to make scales of different maps consistent.

The registration manner refers to a technique of adjusting positions and poses of different maps to make corresponding features coincide.

The dual-precision map refers to a unified map that includes two precisions and that is formed by fusing a high-precision fine-grained map and a low-precision visual dense map.

In some embodiments, the UGV is equipped with a LiDAR, a visual sensor, and an inertial measurement unit (IMU). The UGV is able to autonomously generate a high-precision dense map (i.e., the fine-grained map) by using a multi-sensor fusion manner. However, the high-precision map may be generated only on an operation path of the UGV. A region explored solely by the plurality of UAVs may only transmit back a sparse map (i.e., the lightweight map), which is unable to satisfy a navigation requirement of the UGV. Therefore, a visual dense reconstruction needs to be performed again on the region explored by the plurality of UAVs based on the key visual frame data and the pose of the plurality of UAVs to form a dense map. Original information of the dense map comes from a monocular camera equipped on the plurality of UAVs. A precision of the monocular camera is lower than a precision of a laser sensor, and the dense map has an inevitable scale drift problem inherent in a monocular system. The dense map is a low-precision map (i.e., the lightweight map).

The dense maps of the two precisions are generated from perception data of the UGV and the plurality of UAVs, respectively. The dense maps of the two precisions cover different regions in space and partially overlap. Due to a mapping error, the dense maps of the two precisions may have deviations in positions of obstacle point clouds, making a precise alignment of the dense maps of the two precisions difficult. To improve an overall representation performance of the dual-precision map, the high-precision map in the overlapping region needs to be retained as much as possible, and the low-precision map needs to be deleted. Therefore, the spatial point cloud scaling and registration manner needs to be used to adjust the pose of the low-precision map, so that the two maps may be precisely aligned at the boundary of the high-precision map, and the dual-precision map is obtained.

The maps of the two precisions are both dense maps, and may be converted into an octree spatial occupancy map by using a same manner to form a unified map representation form, and then a same algorithm may be used to complete the path planning. In a unified octree map, undulation changes of the ground are recorded. A local gradient change of a ground segment is used to calculate an undulation slope of the ground G₁. The undulation slope of the ground is used as a cost item for the path planning to reduce ups and downs of a planned path, a smooth travel path for the UGV is provided, and energy consumption is reduced.

An initial slope at a coordinate (x, y) is defined as g(x, y), s is a slope calculation step length, expressed as the following formula (7):

$$g ( x , y ) = tan \sqrt{{( \frac{{h}_{x - s , y} - {h}_{x + s , y}}{2 s} )}^{2} + {( \frac{{h}_{x , y - s} - {h}_{x , y + s}}{2 s} )}^{2}} \qquad ( 7 )$$

In the formula (7), h_{x-s,y} and h_{x+s,y} represent terrain height values at coordinates (x−s, y) and (x+s, y), respectively, h_{x,y-s} and h_{x,y+s} represent terrain height values at coordinates (x, y−s) and (x, y+s), respectively.

The initial slope may be affected by high-frequency information of the terrain and is not easy to represent low-frequency terrain undulation information. Two-dimensional Gaussian convolution K is performed on the initial slope g(·) for Gaussian filtering to eliminate an impact of the high-frequency information, and the undulation slope G₁ is obtained, expressed as the following formula (8):

$${G}_{1} ( x , y ) = c o n v ( {g ( \cdot )}_{x - ns : x + ns , y - ns : y + n s} \cdot {K}^{( 2 n + 1 ) \times ( 2 n + 1 )} ) \qquad ( 8 )$$

In formula (8), g(·) represents an initial slope function. conv represents a two-dimensional convolution operation. K^{(2n+1)×(2n+1)} represents a two-dimensional Gaussian convolution kernel. x−ns: x+ns, y−ns: y+ns represents a spatial range of a convolution operation.

In some embodiments of the present disclosure, by converting the dual-precision map into an octree form and introducing the undulation slope of the ground as a path planning cost item, the UGV can plan a smoother path, reduce energy consumption, and improve exploration efficiency.

Due to different map precisions, the UGV can achieve precise self-positioning in the high-precision map created by the UGV, but a large error occurs in the low-precision map (the lightweight map). While the UGV advances toward the low-precision map, the UGV still continuously uses the first perception module of the UGV to continuously perform mapping and generate a new high-precision map, thereby further pushing back the boundary of the high-precision map and the low-precision map.

In some embodiments of the present disclosure, by fusing the lightweight map of the plurality of UAVs and the fine-grained map of the UGV, combining pose adjustment and overlapping deletion to achieve map alignment, and then expanding the boundary of the fine-grained map as the unmanned ground vehicle advances, a usable dual-precision map is formed, and a high-precision exploration range can be continuously expanded, thereby ensuring the accuracy and continuity of collaborative exploration.

In some embodiments, the collaborative exploration system for the unknown space based on the heterogeneous air-ground robot adopts a low-frequency update strategy. Each time the UGV travels a distance, according to the boundary of a high-precision map and the boundary of the low-precision map, the point cloud scaling and registration manner is reused to correct a deviation at the boundary of the high-precision may and the boundary of the low-precision map. The collaborative exploration system for the unknown space based on the heterogeneous air-ground robot may adopt a strategy of reducing the update frequency of the target position. Each time the UGV travels a distance, according to the boundary of the high-precision map and the low-precision map, point cloud scale scaling and registration are used again to correct the deviation at the boundary, thereby ensuring that the UGV can continuously use the low-precision map for the path planning.

In some embodiments of the present disclosure, through a dual-precision mapping and navigation system of the UGV, combined with high-precision SLAM technology and visual SLAM technology, a dual-precision map including high-precision information and lightweight information is generated. The dual-precision map not only provides fine details of the environment but also covers a wider area, and more comprehensive navigation information for the UGV is provided. A broad field of view of the plurality of UAVs can help the UGV understand the environment structure and the forward traffic condition, so as to enable the UGV to perform path planning and navigation decisions more accurately.

The foregoing descriptions are merely specific implementations of the present disclosure. However, the protection scope of the present disclosure is not limited thereto. Any person skilled in the art can easily conceive of various equivalent modifications or substitutions within the technical scope disclosed in the present disclosure. These modifications or substitutions shall fall within the protection scope of the present disclosure. Therefore, the protection scope of the present disclosure shall be subject to the protection scope of the claims.

What is claimed is:

1. A collaborative exploration system for an unknown space based on a heterogeneous air-ground robot, comprising: an unmanned ground vehicle (UGV) and a plurality of unmanned aerial vehicles (UAVs) loaded on the UGV; wherein the UGV is equipped with a first perception module and a first computing platform configured for constructing a fine-grained map of an environment; each of the plurality of UAVs is equipped with a second perception module and a second computing platform configure for constructing a lightweight map of the environment; and a wireless communication module is disposed in the UGV and each of the plurality of UAVs, and the UGV and the plurality of UAVs communicate via a semi-centralized communication topology;
when the system performs cooperative exploration for the unknown space, the plurality of UAVs explore unknown regions around the UGV with the UGV as a center; based on the second perception module and the second computing platform of each of the plurality of UAVs, the lightweight map is constructed and transmitted back to the UGV; and the UGV fuses the lightweight map transmitted by each of the plurality of UAVs with the fine-grained map constructed by the UGV through the first perception module and the first computing platform.

2. The collaborative exploration system for the unknown space based on the heterogeneous air-ground robot according to claim 1, wherein the wireless communication module is configured to:
designating the UGV as a central communication node and designating the plurality of UAVs as communication nodes to form a UGV-centered communication network, wherein the UGV and the plurality of UAVs communicate directly or indirectly;
when a communication between the UAV and the UGV-centered communication network is interrupted, the UGV determines whether an idle UAV exists at this time; in response to the presence of the idle UAV, dispatch the idle UAV to navigate to a designated position to serve as a communication relay node; in response to the absence of the idle UAV, a disconnected UAV initiating autonomous search for other connectable communication nodes in a surrounding region; if the other connectable communication nodes are found within a preset time interval, directly establish a communication connection; if the other connectable communication nodes are still not found within the preset time interval, the disconnected UAV returning to a position where it was last able to communicate with the UGV-centered communication network; wherein the other connectable communication nodes are the communication relay nodes.

3. The collaborative exploration system for the unknown space based on the heterogeneous air-ground robot according to claim 2, wherein the communication relay nodes move only within a map of an explored region, and calculate an optimal path connecting preceding and succeeding communication nodes by using a search-based algorithm;
a communication node farthest from the central communication node on a communication link is designated as an end communication node, the end communication node is responsible for a perception task, and a target position of the communication relay node is as close as possible to a next node along the optimal path;
after calculating the optimal path connecting the preceding and succeeding communication nodes, a UAV served as the communication relay node starts from a current position and flies along the optimal path from a position close to an upper node toward a lower node; simultaneously, the wireless communication module monitors a strength of a communication signal; and when the strength is less than a preset threshold, the UAV served as the communication relay node lands to perform a communication relay task.

4. The collaborative exploration system for the unknown space based on the heterogeneous air-ground robot according to claim 2, wherein at most one UAV serving as the communication relay node is allowed between the UGV and a UAV for forward perception.

5. The collaborative exploration system for the unknown space based on the heterogeneous air-ground robot according to claim 1, wherein the first perception module includes a visual sensor for capturing visual information of a surrounding environment, a LiDAR for modeling environment into a dense point cloud map, and an inertial measurement unit (IMU) for sensing short-term motion data; and the second perception module includes a visual sensor for performing lightweight mapping of an overall environment and the IMU for sensing the short-term motion data.

6. The collaborative exploration system for the unknown space based on the heterogeneous air-ground robot according to claim 1, wherein the system is further configured to:
perform visual dense low-precision mapping according to the lightweight map, short-term motion data, and key visual frame data transmitted back by the plurality of UAVs;
adjust a pose in the lightweight map transmitted back by the plurality of UAVs by using a spatial point cloud scaling and registration manner, delete a low-precision map at an overlapping region, align a boundary of the fine-grained map constructed by the UGV to obtain a dual-precision map;
during a process of the UGV advancing toward the lightweight map, continuously use the first perception module of the UGV to perform mapping, generate a new fine-grained map, and constantly move a boundary of the fine-grained map and a boundary of the lightweight map backward.

7. The collaborative exploration system for the unknown space based on the heterogeneous air-ground robot according to claim 6, wherein a low-frequency update strategy is adopted; each time the UGV travels a distance, according to a boundary of a high-precision map and a boundary of the low-precision map, the point cloud scaling and registration manner is reused to correct a deviation at the boundary of the high-precision may and the boundary of the low-precision map.

8. The collaborative exploration system for the unknown space based on the heterogeneous air-ground robot according to claim 6, wherein the dual-precision map is represented in a form of an octree map for path planning; according to ground segment data, an undulation slope of the ground is calculated and the undulation slope is used as a cost item in a path planning of the UGV.

9. The collaborative exploration system for the unknown space based on the heterogeneous air-ground robot according to claim 1, wherein
when a plurality of unknown boundaries appear in a map, the first computing platform on the UGV calculates and outputs, via a reinforcement learning algorithm, an unknown boundary index for a next step assigned to the UGV for exploration according to a fused map of an explored region and a set of current unknown boundaries, and assign each remaining secondary unknown boundary to the UAV to explore;
when the plurality of UAVs departs from the UGV, the UGV stops and waits, and determines a next exploration boundary according to an exploration result of the plurality of UAVs;
wherein the reinforcement learning algorithm uses a path length L traveled by the UGV and an elapsed time T as a reward and penalty item of reinforcement learning to dynamically optimize assignment of the plurality of unknown boundaries; and by learning a structural distribution feature in the environment, the UGV selects an unknown boundary with a highest exploration value score from the plurality of unknown boundaries for exploration.

10. The collaborative exploration system for the unknown space based on the heterogeneous air-ground robot according to claim 9, wherein the second computing platform is configured to:
in response to the first computing platform satisfying a first preset condition and a distance between each of the plurality of UAVs and the UGV not exceeding a distance threshold, output the unknown boundary index via the reinforcement learning algorithm according to the fused map of the explored region and the set of current unknown boundaries;
in response to the first computing platform satisfying the first preset condition and the distance between each of the plurality of UAVs and the UGV exceeding the distance threshold,
output UAV motion parameters via the reinforcement learning algorithm, the UAV motion parameters including a movement direction of each of the plurality of UAVs; wherein a state space of the reinforcement learning algorithm includes a self-location, a battery level, and a communication quality metric of each of the plurality of UAVs; an action space is defined as the movement direction of each of the plurality of UAVs; a reward function is constructed based on an exploration area growth rate and an energy consumption metric of each of the plurality of UAVs; the exploration area growth rate is an area of a newly covered unknown region per unit time; the energy consumption metric is determined based on a movement distance and a count of direction changes of each of the plurality of UAVs; and
based on the UAV motion parameters, control a flight control system of each of the plurality of UAVs to cause each of the plurality of UAVs to fly along the movement direction.

11. The collaborative exploration system for the unknown space based on the heterogeneous air-ground robot according to claim 10, wherein the second computing platform is further configured to:
in response to the first computing platform satisfying a second preset condition and the distance between each of the plurality of UAVs and the UGV exceeding the distance threshold, periodically perform following operations according to a preset period:
determining a semantic label based on surrounding environment visual information, short-term motion data, and key visual frame data within the preset period, and transmit the semantic label back to the first computing platform, the semantic label including the self-location and a risk label of each of the plurality of UAVs; wherein a cycle length of the preset period is related to an exploration benefit ratio.

12. The collaborative exploration system for the unknown space based on the heterogeneous air-ground robot according to claim 11, wherein the first computing platform is further configured to:
based on the plurality of semantic labels transmitted back by the plurality of UAVs within a preset time period, determine the next exploration boundary;
after determining the next exploration boundary, periodically perform following operations according to the preset period: based on the plurality of semantic labels transmitted back by the plurality of UAVs, updating the self-locations of the plurality of UAVs, and discarding data transmitted back by the plurality of UAVs.

13. The collaborative exploration system for the unknown space based on the heterogeneous air-ground robot according to claim 9, wherein the second computing platform is further configured to:
in response to a count of UAVs being less than a count of unknown boundaries,
determine UAV exploration parameters based on the count of UAVs and the count of unknown boundaries, the UAV exploration parameters including the unknown boundary index and an exploration distance explored by each of the plurality of UAVs;
based on the UAV exploration parameters, control the plurality of UAVs to obtain exploration area growth rates for a plurality of boundary directions;
based on the exploration area growth rates and the exploration distance, determine a plurality of exploration benefit ratios corresponding to the plurality of boundary directions;
based on the plurality of exploration benefit ratios, determine the unknown boundary index explored by each of the plurality of UAVs; and based on the unknown boundary index explored by each of the plurality of UAVs, control a flight control system of each of the plurality of UAVs to cause each of the plurality of UAVs to fly along a boundary direction corresponding to the unknown boundary index explored by each of the plurality of UAVs.

14. The collaborative exploration system for the unknown space based on the heterogeneous air-ground robot according to claim 1, wherein, if only one unknown boundary exists in a map, exploration is performed in a UGV individual exploration mode, and an unknown boundary tracking algorithm is used to complete an exploration task, specifically: using a geometric center of the unknown boundary as a target point for path planning, and using a search-based path planning manner to obtain a walking path to a target boundary; wherein, during a continuous operation of the UGV, the unknown boundary continuously recedes, and the UGV is configured to calculate the target point once every time the UGV travels a certain distance.
